(19) United States
(12) Patent Application Publication
(10) Pub. No.: US 2021/0142288 A1
(43) Pub. Date: May 13, 2021

(54) TASK REQUEST SYSTEM, INFORMATION PROCESSING APPARATUS, TASK REQUEST METHOD, AND NON-TRANSITORY RECORDING MEDIUM

(71) Applicant: Shimpei NAKAGAWA, Kanagawa (JP)

(72) Inventor: Shimpei NAKAGAWA, Kanagawa (JP)

(73) Assignee: Ricoh Company, Ltd., Tokyo (JP)

(21) Appl. No.: 17/089,027

(22) Filed: Nov. 4, 2020

(30) Foreign Application Priority Data
Nov. 7, 2019 (JP) 2019-202755

(51) Int. Cl. G06Q 10/10; G06Q 10/06; G06Q 30/02; G06F 16/23

(52) U.S. Cl. CPC G06Q 10/103; G06Q 10/063114; G06Q 30/0208; G06Q 30/0215; G06F 9/54; G06Q 10/06398; G06Q 10/107; G06F 16/2379; G06Q 30/0235

(57) ABSTRACT

A task request system includes circuitry configured to receive, from a task requesting person, task request information indicating a request for a task including an indication of a completion time limit, and receive, from a task executing person, task completion information indicating a completion of the task; in response to receiving time limit delay information indicating a delay of the completion time limit that is included in the task request information, provide a first reward that is previously set to the task executing person; and, in response to receiving the task completion information, provide a second reward that is previously set to the task executing person.

### CROSS-REFERENCE TO RELATED APPLICATIONS

The present application is based on and claims priority to Japanese patent application No. 2019-202755 filed Nov. 7, 2019, the contents of which are hereby incorporated herein by reference in their entirety.

### BACKGROUND OF THE INVENTION

### 1. Field of the Invention

The present invention relates to a task request system, an information processing apparatus, a task request method, and a non-transitory recording medium.

### 2. Description of the Related Art

Technologies have been developed to manage requests and responses using e-mails or the like. In addition, point services are provided to general consumers to be used for privileges or discounts in certain retail services. Also, a point service is provided for being used only inside a particular enterprise.

For example, there is disclosed an evaluating apparatus which calculates an evaluation of a respondent as a point score based on e-mails sent and received between an instructor and the respondent.

Japanese Unexamined Patent Application Publication No. 2007-226504 discloses a related art.

### SUMMARY OF THE INVENTION

According to the present disclosure, a task request system includes circuitry configured to receive, from a task requesting person, task request information indicating a request for a task including an indication of a completion time limit; receive, from a task executing person, task completion information indicating a completion of the task; in response to receiving time limit delay information indicating a delay of the completion time limit that is included in the task request information, provide a first reward that is previously set to the task executing person; and, in response to receiving the task completion information, provide a second reward that is previously set to the task executing person.

Other objects, features and advantages of the present invention will become more apparent from the following detailed description when read in conjunction with the accompanying drawings.

### BRIEF DESCRIPTION OF THE DRAWINGS

FIG. 1 is a diagram depicting an example of a system configuration of a task request system according to a first embodiment;

FIG. 2 is a diagram depicting an example of a hardware configuration of an information processing apparatus according to the first embodiment;

FIG. 3 is a diagram depicting an example of functions of the information processing apparatus according to the first embodiment;

FIG. 4 is a diagram depicting an example of task-request task-requesting-person data according to the first embodiment;

FIG. 5 is a diagram depicting an example of task-request task-executing-person data according to the first embodiment;

FIG. 6 is a diagram depicting an example of user data according to the first embodiment;

FIG. 7 is a diagram depicting an example of point setting data according to the first embodiment;

FIG. 8 is a diagram depicting an example of a sequence of a task request process according to the first embodiment;

FIG. 9 is a diagram depicting an example of an initial screen page according to the first embodiment;

FIG. 10 is a diagram depicting an example of a task-requesting-person task list screen page according to the first embodiment;

FIG. 11 is a diagram depicting an example of a task request input screen page according to the first embodiment;

FIG. 12 is a diagram depicting an example of a task-executing-person task list screen page according to the first embodiment;

FIG. 13 is a diagram depicting an example of a task detail screen page according to the first embodiment;

FIG. 14 is a diagram depicting an example of a screen page displayed after points are provided according to the first embodiment;

FIG. 15 is a diagram depicting another example of a task-requesting-person task list screen page according to the first embodiment;

FIG. 16 is a diagram depicting an example of a task status list screen page according to the first embodiment;

FIG. 17 is a diagram depicting an example of a task result confirmation screen page according to the first embodiment;

FIG. 18 is a diagram depicting another example of the task result confirmation screen page according to the first embodiment;

FIG. 19 is a diagram depicting yet another example of the task result confirmation screen page according to the first embodiment;

FIG. 20 is a diagram depicting an example of a sequence of a task request process according to a second embodiment;

FIG. 21 is a diagram depicting an example of a task result confirmation screen page according to the second embodiment; and

FIG. 22 is a diagram depicting an example of task-request point setting data according to a third embodiment.

### DESCRIPTION OF THE EMBODIMENTS

It is important for a task requesting person not only to receive a task completion report but also to know, in a case where a task is delayed, a task execution status by receiving a task delay status report, a delayed time limit, etc. In addition, there may be a problem that a task execution person who executes a task may fail to provide, at each time, a task delay status report, a task completion report, etc., unless there is a clear motivation.

For example, in the above-described evaluating apparatus, the respondent may not have a clear motivation, and thus, it may be difficult to cause the respondent to feel eager to provide a task progress report.

A disclosure is intended to cause a task executing person to feel eager to provide a task progress report.

By using a task request system according to the present disclosure, a task executing person feels eager to provide a task progress report.

### First Embodiment

Hereinafter, a task request system according to a first embodiment of the present invention will be described with reference to drawings.

FIG. 1 is a diagram depicting an example of a system configuration of a task request system according to the first embodiment.

The task request system 1 includes an information processing apparatus 10, a score managing apparatus 20, a score managing database 21, and terminals 30.

The information processing apparatus 10 is connected with the score managing apparatus 20 so as to perform communications together. The information processing apparatus 10 is connected to the terminals 30 through a communication network 40 so as to perform communications together. The information processing apparatus 10 executes various processes which will be described later based on information input from the terminals 30 and causes the terminals 30 to display screen pages or requests the score managing apparatus 20 to provide points.

The score managing apparatus 20 is connected to the score managing database 21 so as to perform communications together. The score managing apparatus 20 performs an update process such as adding or subtracting points in the score managing database 21 upon a request of the information processing apparatus 10 to provide or use points.

The score managing database 21 manages points (a score) of each user. The score managing database 21 is controlled by the score managing apparatus 20 and performs an update process such as adding or subtracting points.

The terminals 30 receive inputs from users or display screen pages. A “terminal 30” is a generic term that does not distinguish individual terminals such as a terminal 30a, a terminal 30b, a terminal 30c, and the like. A user using a terminal 30 may be a task requesting person or a task executing person. That is, each user may be a task requesting person with respect to one task and may be a task executing person with respect to another task.

The communication network 40 is a communication network for wireless or wired communications. The communication network 40 may be, in particular, the Internet, a wide area network (WAN), a local area network (LAN), a virtual private network (VPN), or a combination of any ones of these networks.

FIG. 2 is a diagram depicting an example of a hardware configuration of the information processing apparatus according to the first embodiment.

As depicted in FIG. 2, the information processing apparatus 10 is a computer and includes a CPU 101, a ROM 102, a RAM 103, a HD 104, a HDD (hard disk drive) controller 105, a display 106, an external apparatus connecting interface (I/F) 108, a network I/F 109, a data bus 110, a keyboard 111, a pointing device 112, a digital versatile disk rewritable (DVD-RW) drive 114, and a medium I/F 116.

The CPU 101 controls operations of the entire information processing apparatus 10. The ROM 102 stores a program used to drive the CPU 101, such as an initial program loader (IPL). The RAM 103 is used as a work area of the CPU 101. The HD 104 stores various data such as a program. The HDD controller 105 controls reading or writing of various data with respect to the HD 104 under the control of the CPU 101. The display 106 displays various information such as a cursor, a menu, a screen page, characters, or images.

The external apparatus connecting I/F 108 is an interface for connecting with various external apparatuses or devices. For example, an external apparatus or device is a universal serial bus (USB) memory, a printer, or the like. The network I/F 109 is an interface for performing data communications with a terminal 30 through the communication network 40 or with the score managing apparatus 20. The data bus 110 is an address bus, a data bus, or the like for electrically connecting with elements such as the CPU 101 depicted in FIG. 2.

The keyboard 111 is a type of an input device having a plurality of keys for inputting characters, numbers, various instructions, and the like. The pointing device 112 is a type of an input device for selecting and executing one of various instructions, selecting a processing target, moving a cursor, and the like. The DVD-RW drive 114 controls reading or writing of various data with respect to a DVD-RW 113 as an example of a removable recording medium. Not only a DVD-RW but also a DVD-R, etc., may be used. The medium I/F 116 controls reading or writing (storing) of data with respect to a medium 115, such as a flash memory.

Each of the score managing apparatus 20 and the score managing database 21 has the same hardware configuration as the hardware configuration of the information processing apparatus 10.

Each of the terminals 30 may have a hardware configuration similar to the hardware configuration of the information processing apparatus 10, and may be a smartphone, a wearable PC, a desktop PC, or the like. Each of the terminals 30 may be a multifunction peripheral (MFP), interactive white board (IWB), projector (PJ), digital signage, or the like, provided that the terminal 30 has a browser function.

FIG. 3 is a diagram depicting an example of functions of the information processing apparatus according to the first embodiment.

The information processing apparatus 10 includes a storage unit 11, an input receiving unit 12, a display control unit 13, and a reward providing unit 14.

The storage unit 11 stores various types of data used for various processes performed by the information processing apparatus 10 to be described later. Specifically, the storage unit 11 stores task request data 15, user data 16, and point setting data 17. The details of these types data will be described later.

The input receiving unit 12 receives information from a terminal 30 through operation by a user. Specifically, the input receiving unit 12 receives task request information 51, time limit delay information 52, and task completion information 53.

Task request information 51 is information indicating a task request. The input receiving unit 12 receives task request information 51 from a terminal 30 operated by a user who is a task requesting person.

Task request information 51 includes information such as a task requesting person's user identifier (ID), a task executing person's user ID, a completion time limit, a request description, and so forth.

A task requesting person's user ID is a user ID indicating a task requesting person. A task executing person's user ID is a user ID indicating a task executing person's user IDs are identifiers for identifying users registered in the user data 16. When multiple users request the same task, multiple task executing persons' user IDs are included in a single task request.

Time limit delay information 52 is information indicating a delay of a task completion time limit. The input receiving unit 12 receives time limit delay information 52 from a terminal 30 operated by a task executing person. Time limit delay information 52 includes information such as a task request ID, a task executing person's user ID, and a delayed time limit. A task request ID is an identifier for identifying a task request.

Task completion information 53 is information indicating a task completion. The input receiving unit 12 receives task completion information 53 from a terminal 30 operated by a task executing person. Task completion information 53 includes information such as a task request ID, a task executing person's user ID, task completion text, and the like. A task request ID is an identifier for identifying a task request for each case.

A task completion text is a text indicating that a task has been completed. In a case where a task is executed outside the task request system 1, a task completion text indicates a task completion report.

In a case where a task is completed inside the task request system 1, for example, in a case where a task is to reply to a question, a solicitation of an opinion, or the like, a task completion text may be a reply to the question, an opinion in response to the solicitation, or the like. Thus, in such case, for a task requesting person, a task completion report is not needed because the completion of the task can be confirmed by obtaining a reply, opinion, or the like. Therefore, in such case, a reply to a question, an opinion in response to a solicitation, or the like, functions as a task completion text.

The display control unit 13 controls display made by a terminal 30. Specifically, the display control unit 13 transmits screen page data 54 for displaying various kinds of screen pages to a terminal 30. Screen page data 54 is specifically sent as a hypertext transfer protocol (HTTP) response and is described in a language such as a hypertext markup language (HTML).

The reward providing unit 14 provides a reward to a task executing person. Specifically, one example of a reward is points. The reward providing unit 14 causes the score managing apparatus 20 to perform a point adding process in order to provide points as a reward to a user who inputs time limit delay information 52 or task completion information 53.

Next, various types of data stored in the storage unit 11 will be described.

FIG. 4 is a diagram depicting an example of task-request task-requesting-person data according to the first embodiment.

The task-request task-requesting-person data 15a is part of the task request data 15. Specifically, a data record of task-request task-requesting-person data 15a includes, as items, a task request ID, a task requesting person's user ID, a task name, a completion time limit, and a task description.

A value of an item “request ID” is an identifier for identifying a task request for each case.

A value of an item “task requesting person's user ID” is a user ID indicating a task requesting person.

A value of an item “task name” is a text indicating a name of a task.

A value of an item “completion time limit” is a completion time limit for a task determined by a task requesting person. Specifically, a value of an item “completion time limit” includes year, month, day, hour, and minute.

A value of an item “task description” is a text indicating the contents of a task input by a task requesting person.

FIG. 5 is a diagram depicting an example of task-request task-executing-person data according to the first embodiment.

The task-request task-executing-person data 15b is another part of the task request data 15. The task request data 15 includes the task-request task-requesting-person data 15a and the task-request task-executing-person data 15b.

A data record of task-request task-executing-person data 15b includes, as items, a task request ID, a task executing person's user ID, a delayed time limit, and task completion information.

A value of an item “request ID” is an identifier for identifying a task request for each case. An item “task request ID” of a data record of task-request task-executing-person data 15b is set to be the same value as a value of an item “task request ID” of a corresponding data record of task-request task-requesting-person data 15a, and thus, these two data records are associated with each other.

A value of an item “task executing person's user ID” is a user ID indicating a task executing person.

A value of an item “delayed time limit” is information indicating a delayed time limit for a case where time limit delay information 52 is registered. Specifically, a value of an item “delayed time limit” includes year, month, day, hour, and minute.

A value of an item “task completion text” is a task completion text for a case where task completion information 53 is registered. Specifically, a value of an item “task completion text” is a text indicating a task completion report, a response to a question, an opinion in response to a solicitation, or the like.

A value of an item “not-yet-checked flag” is a flag indicating that a task requesting person has not checked a value yet even when the value is registered at an item “task completion text”. Specifically, a value of an item “not-yet-checked flag” is “1” when a value is registered at an item “task completion text” and a task requesting person has not yet checked the value, or “0” otherwise.

FIG. 6 is a diagram depicting an example of user data according to the first embodiment.

User data 16 is data indicating users of the task request system. Specifically, a data record of user data 16 includes, as items, a user ID, a user name, and an e-mail address.

A value of an item “user ID” is an identifier for identifying a user.

A value of an item “user name” is a text indicating a name of a user.

A value of an item “e-mail address” is a text indicating a user's e-mail address:

FIG. 7 is a diagram depicting an example of point setting data according to the first embodiment.

The point setting data 17 is data indicating settings of providing points. Specifically, a data record of point setting data 17 includes, as items, a point setting ID and the number of providing points.

A value of an item “point setting ID” is an identifier for identifying a point setting.

A value of an item “number of providing points” is the number of providing points.

Specifically, in various processes to be described later, the information processing apparatus 10 determines a point setting ID for each timing of proving points. For example, when time limit delay information 52 is registered, a value of “point setting ID” is set as “P02”.

The information processing apparatus 10 then extracts from the point setting data 17 the value “50” of the number of providing points for the predetermined point setting ID, for example, “P02”.

The information processing apparatus 10 then transmits a signal requesting the score managing apparatus 20 to provide a user with the thus extracted number of providing points.

Next, operations of the task request system 1 will be described with reference to the drawings.

FIG. 8 is a diagram depicting an example of a sequence of a task request process according to the first embodiment.

First, it is assumed that a terminal 30 used by a task requesting person 2 is the terminal 30a, and a terminal 30 used by a task executing person 3 is a terminal 30b. In addition, data records of the task requesting person 2 and the task executing person 3 have been stored as user data 16. Also, it is assumed that the numbers of providing points necessary for a process that will now be described have been already set as point setting data 17.

The task requesting person 2 inputs task request information 51 to the terminal 30a. Specifically, in an initial screen page displayed on the terminal 30a, the task requesting person 2 performs an operation for a transition to a task request input screen page for inputting task request information 51.

FIG. 9 is a diagram depicting an example of the initial screen page according to the first embodiment.

The initial screen page 1000 is a screen page displayed when a request to display a task-requesting-person task list screen page has been received after login user authentication of the task requesting person 2 before the task requesting person 2 making a task request. A task-requesting-person task list screen page is a screen page depicting a list of tasks requested by a user, who has logged in, as a task requesting person.

In order to display the initial screen page 1000 on the terminal 30a, the information processing apparatus 10 receives data to indicate the number of points from the score managing apparatus 20 by invoking an inquiry API or the like provided by the score managing apparatus 20 by indicating the user ID. The display control unit 13 of the information processing apparatus 10 then transmits screen page data 54 for displaying the initial screen page 1000 to the terminal 30a.

Specifically, the initial screen page 1000 includes a score indication 1001, a tab selection field 1002, and a request start button 1003.

The score indication 1001 is an indication of the number of points that the task requesting person 2 has. The number of points is the number of points obtained by the task requesting person as a result of data being received from the score managing apparatus 20.

The tab selection field 1002 is a graphical user interface (GUI) for switching between a task-requesting-person task list screen page and a task-executing-person task list screen page. The tab selection field 1002 of the initial screen page 1000 depicted in FIG. 9 is in a state where a task-requesting-person task list screen page is selected.

A task-executing-person task list screen page is a screen page depicting a list of tasks that a user, who has logged in, is requested to execute as a task executing person.

The request start button 1003 is a GUI for receiving a user's operation for a transition to a task request input screen page. When the request start button 1003 is pressed, the terminal 30a transmits a request for displaying a task request input screen page to the information processing apparatus 10.

After a task request is made by the task requesting person 2, a task-requesting-person task list screen page is displayed instead of the initial screen page.

FIG. 10 is a diagram depicting an example of a task-requesting-person task list screen page according to the first embodiment.

A task-requesting-person task list screen page 1100 includes a score indication 1101, a tab selection field 1102, narrowing down selection buttons 1103, and a request start button 1104. Display contents of a task list will be described later.

The score indication 1101 indicates the number of points that the user who has logged in (i.e., the task requesting person 2) has. Similar to the initial screen page 1000, the number of points obtained is reflected by the information processing apparatus 10 when the information processing apparatus 10 invokes the inquiry API provided by the score managing apparatus 20 or the like.

The tab selection field 1102 is a GUI for switching between a task-requesting-person task list screen page and a task-executing-person task list screen page. The tab selection field 1102 of the task-requesting-person task list screen page 1100 depicted in FIG. 10 is in a state where a task-requesting-person task list screen page has been selected.

The narrowing down selection buttons 1103 are a GUI for receiving a user's indication of a task narrowing down condition to narrow down the tasks displayed in the task list. Specifically, the narrowing down selection buttons 1103 are used to select any one of “All”, “Open” and “Closed” buttons.

When the “All” button is selected, all of the tasks requested by the task requesting person 2 are displayed. When the “Open” button is selected, the tasks that have been requested by the task requesting person 2 and have not yet been completed are displayed. When the “Closed” button is selected, the completed tasks are displayed among the tasks requested by task requesting person 2.

The request start button 1104 is a GUI for receiving a user's operation for a transition to a task request input screen page. Similar to the request start button 1003 of the initial screen page 1000, when the request start button 1104 is pressed, the terminal 30a transmits a request for displaying a task request input screen page to the information processing apparatus 10.

FIG. 11 is a diagram depicting an example of a task request input screen page according to the first embodiment.

The task request input screen page 1200 includes a task name input field 1201, a completion time limit input field 1202, a task description input field 1203, a task executing person input field 1204, a task executing person adding button 1205, a cancel button 1206, and a registration button 1207.

The task name input field 1201 is a text box for inputting a task name.

The completion time limit input field 1202 is a field for inputting a completion time limit. As to a completion time limit, year, month, day, hour, and minute are selected from a pull-down menus. Choices are previously set for each of year, month, day, hour, and minute. For example, selectable days are 30 days after the current date. Selectable hours are every 1 hour from 0:00 through 23:00. Selectable minutes are every 10 minutes from 0 minutes through 50 minutes.

The task input field 1203 is a text area in which a task description is input.

The task executing person input field 1204 is a text box in which a task executing person's e-mail address is input. After the task requesting person 2 has partially input an e-mail address, the terminal 30a may make a display to supplement the input partial e-mail address.

Specifically, the terminal 30a performs a process prescribed in a scripting language program embedded in the screen page data 54 and transmits a request to the information processing apparatus 10 to extract an e-mail address of a task executing person who has previously been requested by the task requesting person 2 on the basis of the task request data 15. When an e-mail address, including the same character string as the already input character string at a head portion, is received from the information processing apparatus 10, the terminal 30a makes a display to supplement the input partial e-mail address.

The task executing person adding button 1205 is a GUI for adding a task executing person. When the task requesting person 2 presses the task executing person adding button 1205, the terminal 30a performs a process prescribed in a scripting language program embedded in the screen page data 54 to additionally display a text box of a task executing person input field 1204.

The cancel button 1206 is a GUI for canceling an input of a task request.

The registration button 1207 is a GUI for registering input information.

When the registration button 1207 is pressed, the terminal 30a transmits the input information as task request information 51 to the information processing apparatus 10, as depicted in FIG. 8 (step S101).

Upon receiving the task request information 51, the input receiving unit 12 of the information processing apparatus 10 reflects the received task request information 51 as task request data 15.

Specifically, the input receiving unit 12 adds a data record of task-request task-requesting-person data 15a as follows.

A value of an item “task request ID” is a value determined by the information processing apparatus 10 so as to be unique in accordance with a predetermined rule.

A value of an item “task requesting person's user ID” is a user ID of the task requesting person 2.

A value of an item “task name” is a text having been input in the task name input field 1201.

A value of an item “completion time limit” is a value having been input in the completion time limit input field 1202.

A value of an item “task description” is a value having been input in the task description input field 1203.

The input receiving unit 12 adds data records of task-request task-executing-person data 15b as many as the number of task executing persons having been input in the task executing person input field 1204 as follows.

In each of the data records, a value of an item “request ID” is the same as the value of the item “request ID” in the corresponding data record of task-request task-requesting-person data 15a.

A value of an item “task executing person's user ID” is a user ID of a task executing person having been input in the task executing person input field 1204.

A value of an item “delayed time limit” is, at this time, null. The value of the item “delayed time limit” is updated by a process that will be described later.

A value of an item “task completion text” is also null at the present time. The value of the “task completion text” is also updated by a process that will be described later.

A value of an item “not-yet-checked flag” is set to be “0”.

In step S102, the input receiving unit 12 transmits a task request notifying e-mail to the terminal 30b used by a task executing person 3. The task request notifying e-mail is an e-mail notifying the task executing person 3 that a task request has been made. An e-mail address of the task request notifying e-mail is an e-mail address of the task executing person 3. A body of the task request notifying e-mail includes a link for displaying a task detail screen page.

In step S103, when the task executing person 3 clicks the link included in the body of the task request notifying e-mail with the pointing device such as the mouse (or taps a screen page of a smartphone or the like), the terminal 30b transmits a task-detail-screen-page display request signal to the information processing apparatus 10. The task-detail-screen-page display request signal is a signal requesting a display of a task detail screen page, specifically, a HTTP request, etc. The task detail screen page displays details of a task requested by the task requesting person 2.

Next, in step S104, the display control unit 13 of the information processing apparatus 10 transmits task detail screen page data to the terminal 30b. The task detail screen page data is screen page data 54 of a task detail screen page.

In step S104, the display control unit 13 determines whether login authentication as a user of the task executing person 3 is successful, and when login authentication is not successful, screen page data 54 for login authentication may be transmitted. In this case, the display control unit 13 transmits the task detail screen page data to the terminal 30b after the login authentication is successful.

Session information with respect to a session for obtaining a state where login authentication is successful may be embedded in the link included in the body of the task request notifying e-mail, and the session information may be caused to be included in the task-detail-screen-page display request signal. In this case, the information processing apparatus 10 transmits the task detail screen page data, in a state where login authentication on the task executing person 3 as a user is successful, to the terminal 30b.

In step S105, the terminal 30b displays the task detail screen page according to the received task detail screen page data.

In steps S103-S105, a task-executing-person task list screen page may be used instead of the task detail screen page. In this case, the terminal 30b transmits a task detail screen page display request signal to the information processing apparatus 10 after receiving from the task executing person 3 a selection of a task from the task list screen page, after step S105.

FIG. 12 is a diagram depicting an example of a task-executing-person task list screen page according to the first embodiment.

The task-executing-person task list screen page 1300 includes a score indication 1301, a tab selection field 1302, narrowing down selection buttons 1303, a status indication 1304, a task name indication 1305, a completion time limit indication 1306, and a detail link 1307.

The status indication 1304, the task name indication 1305, the completion time limit indication 1306, and the detail link 1307 are included in a task list indication field and are displayed for each task.

The score indication 1301 indicates the number of points that a user (the task executing person 3), who has logged in, has. Similar to the initial screen page 1000, the number of points obtained are reflected when the information processing apparatus 10 invokes an inquiry API provided by the score managing apparatus 20 or the like.

The tab selection field 1302 is a GUI for switching between a task-requesting-person task list screen page and a task-executing-person task list screen page. In the tab selection field 1302 of the task-executing-person task list screen page 1300 depicted in FIG. 12, the task-executing-person task list screen page has been selected.

The narrowing down selection buttons 1303 are a GUI used for receiving an indication of a narrowing down condition for narrowing down the tasks displayed in the task list. Specifically, similarly to the narrowing down selection buttons 1103 of the task-requesting-person task list screen page 1100, the narrowing down selection buttons 1303 are used to select any one of “All”, “Open”, and “Closed” buttons.

The status indication 1304 is an indication as to whether a task has been completed or not. The status indication 1304 reflects whether a value is registered at the item “task completion text” for each of all data records included in the task-request task-executing-person data 15b.

That is, if a value is registered at the item “task completion text” for each of all the task executing persons' data records, the status indication 1304 indicates that the tasks have been completed. If values are not registered in the items “task completion text” of the data records of one or more task executing persons, the status indication 1304 is an indication that tasks have not been completed.

The task name indication 1305 is a text indicating a task name. The task name indication 1305 reflects a value of the item “task name” of a corresponding set of task-request task-requesting-person data 15a.

The completion time limit indication 1306 is an indication of a completion time limit of a task. The completion time limit indication 1306 reflects a value of the item “completion time limit” of a corresponding set of task-request task-requesting-person data 15a.

The detail link 1307 is a GUI for receiving a user's operation for a transition to a task detail screen page.

When the detail link 1307 is clicked (or tapped), the terminal 30b obtains screen page data 54 from the information processing apparatus 10 and displays a task detail screen page.

FIG. 13 is a diagram depicting an example of a task detail screen page according to the first embodiment.

The task detail screen page 1400 includes a task name indication 1401, a status indication 1402, a task description indication 1403, an delayed time limit input field 1404, a task completion text input field 1405, a cancel button 1406, and an registration button 1407.

The task name indication 1401 is a text indicating a task name. The task name indication 1401 reflects a value of the item “task name” of a corresponding set of task-request task-requesting-person data 15a.

The status indication 1402 is an indication as to whether a task has been completed. The status indication 1402 reflects whether a value is registered at the item “task completion text” of the corresponding data record of the task executing person 3 included in the task-request task-executing-person data 15b.

The task description indication 1403 is a text indicating a task description input by the task requesting person 2. The task description indication 1403 reflects a value of the item “task description” of a corresponding data record of task-request task-requesting-person data 15a.

The delayed time limit input field 1404 is a GUI for receiving an delay time limit input from the task executing person 3. Specifically, a delayed time limit that can be input at the delayed time limit input field 1404 is year, month, day, hour, and minute.

If a value of the item “delayed time limit” of a data record of the task-request task-executing-person data 15b is not null (empty), the value is initially displayed at the delayed time limit input field 1404. If the item “delayed time limit” of a data record of the task-request task-executing-person data 15b is null (empty), nothing is displayed at the delayed time limit input field 1404.

A delayed time limit that can be input by the task executing person 3 is a time in a range between a completion time limit and the date and minute at the expiry of a predetermined allowed delay time. The predetermined allowed delay time is a period for which a delay is allowed and is a set value that is stored in the storage unit 11 or the like.

The task completion text input field 1405 is a GUI for receiving a task completion text input by the task executing person 3.

The cancel button 1406 is a GUI for canceling an input of a delayed time limit or a task completion text.

The registration button 1407 is a GUI for registering information that has been input.

In step S106, when the registration button 1407 is pressed while a delayed time limit has been input, the terminal 30b transmits the input information as time limit delay information 52 to the information processing apparatus 10 as depicted in FIG. 8.

The input receiving unit 12 of the information processing apparatus 10 updates the corresponding data record of task-request task-executing-person data 15b based on the received time limit delay information 52. The value of the item “delayed time limit” is updated to the delayed time limit according to the time limit delay information 52.

The input receiving unit 12 of the information processing apparatus 10 does not update the corresponding data record of task-request task-executing-person data 15b when the current date and time have already passed the completion time limit. In this case, steps S107-S111 are not performed. In addition, the display control unit 13 transmits screen page data 54 of an error screen page, including a message indicating that the completion time limit has already been passed, to the terminal 30b.

Next, in step S107, the reward providing unit 14 of the information processing apparatus 10 transmits a point providing request signal to the score managing apparatus 20. The point providing request signal includes the user ID of the task executing person 3 and the number of providing points. The reward providing unit 14 obtains the number of providing points from the point setting data 17.

Specifically, among the data records of the point setting data 17, the reward providing unit 14 refers to a data record in which the value of the item “point setting ID” is a value (for example, “P02”) predetermined to be used in step S107.

The reward providing unit 14 obtains the value (for example, 50) at the item “number of providing points” of the referred data record from the point setting data 17 as data of the number of providing points.

The point providing request signal may be a signal for invoking a point providing API prescribed in the score managing apparatus 20.

Next, in step S108, the score managing apparatus 20 transmits a score data update request signal to the score managing database 21. The score data update request signal is a signal that requests update by adding the given number of points to the number of points with respect to a given user ID.

In step S109, the score managing database 21 performs a score data update process. A score data update process is a process of updating score data according to a request signal. Specifically, the number of points that the given user ID has is updated as a result of the given number of points being added.

In this regard, when a time limit is set to score data, the score managing database 21 may perform a process of updating the time limit date.

In step S110, the score managing database transmits a success signal to the score managing apparatus 20. The success signal is a signal indicating that the score data update process is successful.

In step S111, the score managing apparatus 20 transmits a success signal to the information processing apparatus 10. The success signal is a signal indicating that the number points have been provided with respect to the given user ID.

Thus, according to the task request system 1, a task executing person 3 who inputs time limit delay information 52 is provided with a corresponding number of points (a first reward).

In step S112, when the registration button 1407 is pressed while a task completion text is input, the terminal 30b transmits the input information as task completion information 53 to the information processing apparatus 10.

The input receiving unit 12 of the information processing apparatus 10 updates the corresponding data record of task-request task-executing-person data 15b based on the received task completion information 53. The value of the item “task completion text” is updated to the task completion text included in the task completion information 53. The value of the item “not-yet-checked flag” is updated to “1”.

Next, in step S113, the reward providing unit 14 of the information processing apparatus 10 transmits a point providing request signal to the score managing apparatus 20. The point providing request signal includes the user ID of the task executing person 3 and the number of providing points. The reward providing unit 14 obtains the number of providing points from the point setting data 17.

Specifically, among the data records of the point setting data 17, the reward providing unit 14 refers to a data record in which the value of the item “point setting ID” is a value predetermined as a value to be used in step S113.

The reward providing unit 14 then obtains the value of the item “number of providing points” of the referred data record from the point setting data 17 as data of the number of providing points.

In this regard, the reward providing unit 14 performs a different process according to the date and time when the task completion text is input.

Specifically, when a delayed time limit is not input and the date and time when the task completion text is input is before the completion time limit, for example, the reward providing unit 14 uses a set value “P01”.

When a delayed time limit has already been input, and the date and time at which the task completion text is input is after the completion time limit and before the delayed time limit, for example, the reward providing unit 14 uses a set value “P03”.

The reward providing unit 14 does not transmit a point providing request signal (a) when a delayed time limit is not input, and the date and time at which the task completion text is input is later than the completion time limit, or (b) when a delayed time limit is already input and the date and time at which the task completion text is input is later than the delayed time limit. This is because the time limit has already been passed.

Steps S114-S117 are the same as steps S108-S111 described above.

Thus, according to the task request system 1, a task executing person 3 who inputs task completion information 53 is provided with the predetermined number of points (a second reward).

FIG. 14 is a diagram depicting an example of a screen page displayed after points are thus provided according to the first embodiment.

As described above, when step S109 or step S115 has been completed, the score data in the score managing database 21 is updated. Accordingly, when the terminal 30b transmits a signal indicating a request for displaying any one of screen pages for each of which the task executing person 3 is the login user to the information processing apparatus 10, the display control unit 13 transmits screen page data 54 in which the number of points after being updated is reflected to the terminal 30b. For example, the number of points displayed as the score indication 1501 of the task-executing-person task list screen page 1500 depicted in FIG. 14 has been changed from, for example, 0 to 100.

In step S117 of FIG. 8, when a success signal from the score managing apparatus 20 is received, the information processing apparatus 10 transmits a task completion notifying e-mail to the terminal 30a (step S118). A task completion notifying e-mail is an e-mail notifying task requesting person 2 that the task has been completed. The destination of the task completion notifying e-mail is an e-mail address of the task requesting person 2. The body of the task completion notifying e-mail includes a link for displaying a task result confirmation screen page.

In step S119, when the task requesting person 2 clicks the link included in the body of the task completion notifying e-mail by a pointing device such as a mouse (or taps the screen page of a smartphone or the like), the terminal 30a transmits a task result confirmation screen page display request signal to the information processing apparatus 10. The task result confirmation screen page display request signal is a signal requesting a display of a task result confirmation screen page, specifically a HTTP request, etc. The task result confirmation screen page is a screen page for displaying a task completion text input by the task executing person 3.

When the value of the item “not-yet-checked flag” is “1” in the corresponding data record, the information processing apparatus 10 updates the value to “0”. In step S120, the display control unit 13 transmits task result confirmation screen page data to the terminal 30a. The task result confirmation screen page data is screen page data 54 of a task result confirmation screen page.

In step S120, the display control unit 13 determines whether login authentication has been made on the task requesting person 2 as a user, and when login authentication has not been made, screen page data 54 for login authentication may be transmitted. In this case, the display control unit 13 transmits task result confirmation screen page data to the terminal 30a after determining that the login authentication is successful.

Session information with respect to a session for obtaining a state where login authentication is successful may be embedded in the link included in the body of the task completion notifying e-mail, and the session information may be caused to be included in the task result confirmation screen page display request signal. In this case, the information processing apparatus 10 transmits the task result confirmation screen page data, in a state where login authentication is successful on the task requesting person 2 as a user, to the terminal 30a.

In step S121, the terminal 30a displays the task result confirmation screen page according to the received task result confirmation screen page data.

In steps S119-S121, a task-requesting-person task list screen page may be used instead of the task result confirmation screen page. In this case, the terminal 30a transmits a task-status-list-screen-page display request signal to the information processing apparatus 10 after receiving a selection of a task by the task requesting person 2 from the task-requesting-person task list screen page after step S121.

FIG. 15 is a diagram depicting another example of a task-requesting-person task list screen page according to the first embodiment.

The task-requesting-person task list screen page 1600 is a screen page depicting a list of tasks for the task requesting person for a case where multiple tasks are requested by a user who has logged in. The list of tasks in the task-requesting-person task list screen page 1600 includes a progress indication 1601, a completion time limit indication 1602, a not-yet-checked mark 1603, and a task status list link 1604 for each task.

The progress indication 1601 is an indication of the progress of the task. Specifically, the progress indication 1601 indicates the ratio of the number of task executing persons who have completed tasks to the number of task executing persons whom tasks have been requested to execute.

When generating a task-requesting-person task list screen page data, the display control unit 13 calculates the ratio of the number of task executing persons who have completed tasks to the number of task executing persons whom tasks have been requested to execute according to whether values are registered at the items “task completion text” referring to the task-request task-executing-person data 15b. The display control unit 13 uses a display image selected from among a plurality of previously generated display images as the progress indication 1601 based on the calculated ratio.

The display control unit 13 may newly generate such a display image on a case-by-case basis based on a calculated ratio to display the progress indication 1601.

The completion time limit indication 1602 is an indication of a completion time limit. The completion time limit indication 1602 is a colored display that includes a text indicating the date and time of the completion time limit with the color depending on the relationships between the current date and time and the completion time limit. For example, the color of the completion time limit indication 1602 may be red if the current date and time exceeds the completion time limit; yellow if the current date and time are approaching the completion time limit, for example, less than one day before the completion time limit; and blue otherwise.

The not-yet-checked mark 1603 is an indication that the task requesting person 2 has not yet seen the task completion text of any one of the task executing persons 3 with respect to the task.

Specifically, when generating a task-requesting-person task list screen page data, the display control unit 13 displays a not-yet-checked mark 1603 when one or more data records each having the value “1” at the item “not-yet-checked flag” among the data records with respect to the corresponding work executing persons are included in the task-request task-executing-person data 15b.

The task status list link 1604 is a GUI for receiving a user's operation for a transition to a task status list screen page.

When the task status list link 1604 is clicked (or tapped), the terminal 30a obtains corresponding screen page data 54 from the information processing apparatus 10 and displays a task status list screen page as depicted in FIG. 16.

The task status list screen page 1700 depicted in FIG. 16 is a screen page depicting a list of the task status of each task executing person. Specifically, the task status list screen page 1700 includes, for each task executing person, a status indication 1701, a task executing person's e-mail address indication 1702, a time limit indication 1703, a not-yet-checked mark 1704, a task result confirmation link 1705, and a task deletion button 1706.

The status indication 1701, the task executing person's e-mail address indication 1702, the time limit indication 1703, the not-yet-checked mark 1704, and the task result confirmation link 1705 are included in a task status list display field and are displayed for each task executing person.

The status indication 1701 is an indication as to whether the task has been completed. The status indication 1701 reflects whether a value is registered at the item “task completion text” of the data record of the corresponding task executing person in the task-request task-executing-person data 15b.

The task executing person's e-mail address indication 1702 is an indication of the task executing person's e-mail address. The task executing person's e-mail address indication 1702 reflects the value at the item “e-mail address” of the task executing person's data record of the user data 16.

The time limit indication 1703 is a text indicating the completion time limit determined by the task requesting person 2 or the extended time limit registered by the task executing person.

Specifically, when a value is registered at the item “delayed time limit” of the data record of the task executing person included in the task-request task-executing-person data 15b, the value at the item “delayed time limit” is reflected in the time limit indication 1703 and is displayed in yellow.

When a value is not registered at the item “delayed time limit” of the data record of the task executing person included in the task-request task-executing-person data 15b, the item “completion time limit” included in the task-request task-requesting-person data 15a is reflected in the time limit indication 1703 and is displayed in red.

The not-yet-checked mark 1704 is an indication that the task requesting person 2 has not yet seen the task executing person's task completion text. The not-yet-checked mark 1704 is displayed when the value at the item “not-yet-checked flag” of the data record of the task executing person included in the task-request task-executing-person data 15b is “1”.

The task result confirmation link 1705 is a GUI for receiving a user's operation for a transition to a task result confirmation screen page with respect to the task executing person.

When the task result confirmation link 1705 is clicked (or tapped), the terminal 30a transmits a task result confirmation screen page display request signal to the information processing apparatus 10. When the value at the item “not-yet-checked flag” is “1” in the corresponding data record, the information processing apparatus 10 updates the value to “0”. The display control unit 13 transmits task result confirmation screen page data to the terminal 30a.

The task deletion button 1706 is a GUI for receiving a user's operation to delete the task.

When the task deletion button 1706 is pressed, the terminal 30a transmits a task deletion request signal to the information processing apparatus 10. In response, the information processing apparatus 10 deletes the corresponding task request data 15. The information processing apparatus 10 may transmit a task deletion notifying e-mail to a task executing person with respect to the deleted task, if any, who has not completed the task.

FIG. 17 is a diagram depicting an example of a task result confirmation screen page according to the first embodiment.

The task result confirmation screen page 1800 is an example of a task result confirmation screen page when values are not registered at both the item “delayed time limit” and the item “task completion text” of a data record of task-request task-executing-person data 15b.

The task result confirmation screen page 1800 includes a status indication 1801, a task completion text indication 1802, and a task executing person deletion button 1803.

The status indication 1801 is an indication as to whether the task has been completed. The status indication 1801 reflects whether a value is registered at the item “task completion text” of the data record of task-request task-executing-person data 15b.

In the example depicted in FIG. 17, because a value is not registered at the item “task completion text” of the data record of task-request task-executing-person data 15b, the status indication 1801 indicates that the task has not been completed.

The task completion text indication 1802 is an indication of a task completion text. The task completion text indication 1802 reflects a value at the item “task completion text” of the data record of task-request task-executing-person data 15b.

In the example depicted in FIG. 17, because a value is not registered at the item “task completion text” of the data record of task-request task-executing-person data 15b, the task completion text indication 1802 indicates that a value is not registered.

The task executing person deletion button 1803 is a GUI for receiving a user's operation to delete the task executing person from the task.

When the task executing person deletion button 1803 is pressed, the terminal 30a transmits a task executing person deletion request signal to the information processing apparatus 10. The information processing apparatus 10 then deletes the corresponding data record of task-request task-executing-person data 15b.

In the example of FIG. 17, because the task executing person has not completed the task yet, the information processing apparatus 10 may transmit a task deletion notifying e-mail to the task executing person.

FIG. 18 is a diagram depicting another example of a task result confirmation screen page according to the first embodiment.

The task result confirmation screen page 1900 is an example of a task result confirmation screen page when a value is registered at the item “delayed time limit” and a value is not registered at the item “task completion text” in a data record of task-request task-executing-person data 15b

The task result confirmation screen page 1900 includes a status indication 1901, an delayed time limit indication 1902, a task completion text indication 1903, and a task executing person deletion button 1904.

The status indication 1901 is an indication as to whether the task has been completed. The status indication 1901 reflects whether a value is registered at the item “task completion text” of the data record of task-request task-executing-person data 15b.

In the example depicted in FIG. 18, because a value is not registered at the item “task completion text” of the data record of task-request task-executing-person data 15b, the status indication 1901 indicates that the task has not been completed.

The delayed time limit indication 1902 is an indication of a delayed time limit. The delayed time limit indication 1902 reflects the value at the item “delayed time limit” in the data record of task-request task-executing-person data 15b.

The task completion text indication 1903 is an indication of a task completion text. The task completion text indication 1903 reflects the value at the item “task completion text” of the data record of task-request task-executing-person data 15b.

In the example depicted in FIG. 18, because a value is not registered at the item “task completion text” of the record of task-request task-executing-person data 15b, the task completion text indication 1903 indicates that a value is not registered.

The task executing person deletion button 1904 is a GUI for receiving a user's operation to delete the task executing person from the task.

When the task executing person deletion button 1904 is pressed, the terminal 30a transmits a task executing person deletion request signal. The information processing apparatus 10 then deletes the corresponding data record of task-request task-executing-person data 15b.

In the example of FIG. 18, because the task executing person has not completed the task yet, the information processing apparatus 10 may transmit a task deletion notifying e-mail to the task executing person.

FIG. 19 is a diagram depicting another example of a task result confirmation screen page according to the first embodiment.

The task result confirmation screen page 2000 is an example of a task result confirmation screen page when a value is registered at the item “task completion text” of a data record of task-request task-executing-person data 15b.

The task result confirmation screen page 2000 includes a status indication 2001, a task completion text indication 2002, and a task executing person deletion button 2003.

The status indication 2001 is an indication of whether the task has been completed or not. The status indication 2001 reflects whether a value is registered at the item “task completion text” of the data record of the task-request task-executing-person data 15b.

In the example of FIG. 19, because a value is registered at the item “task completion text” of the data record of task-request task-executing-person data 15b, the status indication 2001 indicates that a task is completed.

The task completion text indication 2002 is an indication of a task completion text. The task completion text indication 2002 reflects a value at the item “task completion text” of the data record of task-request task-executing-person data 15b.

The task executing person deletion button 2003 is a GUI for receiving a user's operation to delete the task executing person from the task.

When the task executing person deletion button 2003 is pressed, the terminal 30a transmits a task executing person deletion request signal to the information processing apparatus 10. The information processing apparatus 10 then deletes the corresponding data record of task-request task-executing-person data 15b.

Thus, according to the task request system 1 of the present embodiment, a task executing person who inputs time limit delay information 52 is provided with a corresponding number of points, so that the task executing person feels eager to input time limit delay information 52. Time limit delay information 52 is an example of a task progress report to indicate an expectation as to when a task will be completed.

In addition, because a corresponding number of points are provided to a task executing person who inputs task completion information 53, the task executing person feels eager to input task completion information 53. Task completion information 53 is another example of a task progress reporting to indicate an expectation as to a time of task completion.

Even if a completion time limit is passed, a corresponding number of points will be provided to a task executing person through an input of a task completion text before a delayed time limit as long as the task executing person has input time limit delay information 52 before the completion time limit. Before a completion time limit is passed, time limit delay information 52 can be input. This provides a benefit of inputting time limit delay information 52 to a task executing person, thereby it being able to cause the task executing person to further feel eager to input time limit delay information 52.

In addition, with respect to point setting data 17, an example, in which the total number of points (for example, 100) of the number of points (for example, 50) provided through an input of time limit delay information 52 and the number of points (for example, 50) provided through an input of task completion information 53 after the input of the time limit delay information 52 is the same as the number of points (for example, 100) provided through an input of task completion information 53 before the completion time limit, has been described.

In other words, a total value of a first reward and a second reward that is provided when task completion information 53 is input before a delayed completion time limit is the same as a value of a second reward provided when time limit delay information 52 is not input and task completion information 53 is input before a completion time limit included in task request information 51.

According to such a setting of point setting data 17, there is no disadvantage of inputting time limit delay information 52, so that it is possible to cause a task executing person to further feel eager to input time limit delay information 52.

Further, a setting of point setting data 17 may be another setting. For example, the number of points (e.g., 120) provided through an input of task completion information 53 before a completion time limit may be set greater than the total number of points (e.g., 100) of the number of points (e.g., 50) provided through an input of time limit delay information 52 and the number of points (e.g., 50) provided through an input of task completion information 53 after the input of time limit delay information 52.

Such a setting (the above-mentioned “another setting”) of point setting data 17 may cause a task executing person to feel eager to input task completion information 53 within a completion time limit. Further, although there is a disadvantage in inputting time limit delay information 52, it is advantageous to input time limit delay information 52 in comparison to a case of passing a completion time limit without inputting time limit delay information 52, so it is possible to cause a task executing person to feel eager to input time limit delay information 52.

The reward providing unit 14 of the information processing apparatus 10 may, when a plurality of task executing persons is requested to execute one task, provide additional points to a task executing person who first inputs a task completion information 53. Thus, a task executing person may obtain additional points by completing a task and inputting task completion information 53 earlier, and thus, it is possible to cause a task executing person to further feel eager to input task completion information 53.

In the present embodiment, after step S111 of a task request process depicted in FIG. 8, an e-mail notifying that time limit delay information 52 has been input may be sent to a task requesting person 2. Thus, the task requesting person 2 can know immediately that the time limit delay information 52 has been input and can easily know the actual progress of the task.

### Second Embodiment

A second embodiment will now be described with reference to the drawings. The second embodiment differs from the first embodiment in that points are provided to a task executing person, not as a result of acceptance information being input but as a result of acceptance information being input by a task requesting person. In the description of the second embodiment below, differences from the first embodiment are described. Elements having functional configurations similar to the elements of the first embodiment are given the same reference numerals used in the description of the first embodiment, and the duplicate description may be omitted.

FIG. 20 is a diagram depicting an example of a sequence of a task request process according to the second embodiment.

The task request process according to the present embodiment includes the same steps as steps S101 to S111 of the task request process according to the first embodiment depicted in FIG. 8, and these steps are omitted in FIG. 20.

In step S201 executed after step S111 that is not depicted in FIG. 20 as mentioned above, when the task executing person 3 performs an operation of inputting task completion information 53, the terminal 30b transmits task completion information 53 to the information processing apparatus 10.

The input receiving unit 12 of the information processing apparatus 10 updates the corresponding data record of task-request task-executing-person data 15b based on the received task completion information 53. Specifically, the value of the item “task completion text” is updated to the task completion text included in the task completion information 53. The value of the item “not-yet-checked flag” is updated to “1” accordingly.

In step S202, the information processing apparatus 10 transmits a task completion notifying e-mail to the terminal 30a.

In step S203, when the task requesting person 2 clicks (or taps) a link included in the body of the task completion notifying e-mail, the terminal 30a transmits a task result confirmation screen page display request signal to the information processing apparatus 10.

When the value of the item “not-yet-checked flag” of the corresponding data record is “1”, the information processing apparatus 10 updates the value to “0”. In step S204, the display control unit 13 transmits task result confirmation screen page data to the terminal 30a.

In step S205, the terminal 30a displays a task result confirmation screen page according to the received task result confirmation screen page data.

FIG. 21 is a diagram depicting an example of a task result confirmation screen page according to the second embodiment.

The task result confirmation screen page 2100 according to the present embodiment includes a re-request button 2101 and a confirm (accept) button 2102.

Returning to FIG. 20, when the confirm button 2102 is pressed, the terminal 30a transmits acceptance information to the information processing apparatus 10 in step S206.

Next, in step S207, the reward providing unit 14 of the information processing apparatus 10 transmits a point providing request signal to the score managing apparatus 20. The point providing request signal is a signal indicating a request to provide points, including a user ID of the task executing person 3 and the number of providing points.

The reward providing unit 14 obtains information of the number of providing points from the point setting data 17. Specifically, among the data records of the point setting data 17, the reward providing unit 14 refers to a data record in which the value of the item “point setting ID” is a value predetermined as a value to be used in step S207.

The reward providing unit 14 obtains the value of the item “number of providing points” of the referred data record from the point setting data 17 as data of the number of providing points.

The reward providing unit 14 performs a different process according to the date and time when the task completion text is input.

Specifically, when a delayed time limit is not input and the date and time when the task completion text is input is before the completion time limit, for example, the reward providing unit 14 uses a set value “P01”.

When a delayed time limit has already been input and the date and time when the task completion text is input is after the completion time limit and before the delayed time limit, for example, the reward providing unit 14 uses a set value “P03”.

The reward providing unit 14 does not transmit a point providing request signal when (a) a delayed time limit is not input and the date and time when the task completion text is input is later than the completion time limit, or (b) a delayed time limit is already input and the date and time when the task completion text is input is later than the delayed time limit. This is because the time limit has already passed.

A point providing request signal may be a signal to invoke a point providing API prescribed in the score managing apparatus 20.

Next, in step S208, the score managing apparatus 20 transmits a score data update request signal to the score managing database 21.

In step S209, the score managing database 21 performs a score data update process.

Specifically, the number of points that the given user ID has is updated as a result of the given number of points being added.

In step S210, the score managing database 21 transmits a success signal to the score managing apparatus 20. The success signal is a signal indicating that the point update process is successful.

In step S211, the score managing apparatus 20 transmits a success signal to the information processing apparatus 10. The success signal is a signal indicating that the number of points have been provided with respect to the given user ID.

Thus, according to the task request system 1 of the present embodiment, when acceptance information is input from a task requesting person 2, a task executing person 3 who registers task completion information 53 is provided with a corresponding number of points (a second reward).

When receiving a success signal from the score managing apparatus 20, the information processing apparatus 10 transmits an acceptance notifying e-mail to the terminal 30b (step S212). An acceptance notifying e-mail is an e-mail notifying a task executing person 3 that the task result is accepted. An e-mail address of the acceptance notifying e-mail is an e-mail address of a task executing person 3.

When the re-request button 2101 of the task result confirmation screen page 2100 is clicked, the terminal 30a displays a screen page similar to the task request input screen page depicted in FIG. 11 and receives an input of task re-request. In step S213, when the registration button is pressed by the task requesting person 2, the terminal 30a transmits the input information as task re-request information to the information processing apparatus 10. The task re-request information is information indicating the contents of the task re-request.

When the task re-request information is received, the input receiving unit 12 of the information processing apparatus 10 reflects the received task re-request information in the corresponding data record of task request data 15 in the same manner as the case where the task request information is received in step S101 depicted in FIG. 8.

The input receiving unit 12 registers the data record of the task-request task-requesting-person data 15a registered in step S101 in association with the data record of the task-request task-requesting-person data 15a registered in step S213.

In step S214, the input receiving unit 12 transmits a task re-request notifying e-mail to the terminal 30b used by the task executing person 3. The task re-request notifying e-mail is an e-mail notifying that the task has been re-requested to the task executing person 3. An e-mail address of the task re-request notifying e-mail is an e-mail address of the task executing person 3. The body of the task re-request notifying e-mail includes a link for displaying a task detail screen page.

The subsequent process is the same as step S103 of FIG. 8. However, when a task-detail-screen-page-data display request signal is received from the terminal 30b operated by the task executing person 3, the information processing apparatus 10 transmits task detail screen page data reflecting the information of the data record of the task-request task-requesting-person data 15a registered in step S213 to the terminal 30b.

According to the task request system 1 of the present embodiment, points are provided to a task executing person not at the time when the task executing person has input task completion information but at the time when a task requesting person accepts the task result. Thus, the completion of the task can be confirmed not only by determination of the task executing person but also by determination of the task requesting person. For example, it is possible to avoid a problematic situation where, in a case where a task executing person's task completion information is not sufficient, the request is repeated, and thus, points are provided to the task executing person too much.

In addition, by managing a task re-request in conjunction with an original task request, a task requesting person can provide additional information to a task executing person while avoiding a useless increase in the number of tasks in a task list otherwise occurring due to an addition of a task itself.

### Third Embodiment

A third embodiment will now be described with reference to the drawings. The third embodiment differs from the first embodiment in that a task requesting person determines the number of points to be provided to a task executing person. In the following description of the third embodiment, differences from the first embodiment are described. Elements having the same functional configurations as elements of the first embodiment are given the same reference numerals as the reference numerals used in the description of the first embodiment, and the duplicate description may be omitted.

The information processing apparatus 10 according to the present embodiment sets the number of points to be provided to a task executing person when a task requesting person 2 inputs task request information 51 by operating a terminal 30a. In this regard, in another example, the task requesting person 2 need not set the number of points, and in such a case, the number of points prescribed in the point setting data 17 are provided to a task executing person.

The number of points to be set is determined according to the item “point setting ID” included in the point setting data 17. For example, the number of points according to any one of three patterns “P01”, “P02”, and “P03” are set.

When task request information 51 includes information on a setting of the number of points, the input receiving unit 12 of the information processing apparatus 10 stores the information of the set number of points in the storage unit 11 as task-request point setting data.

FIG. 22 is a diagram depicting an example of task-request point setting data according to the third embodiment.

The task-request point setting data 18 includes, as an item, a task request ID, a point setting ID, and the number of providing points.

A value of the item “task request ID” is an identifier for identifying a task request for each case. The item “task request ID” of a data record of task-request point setting data 18 has the same value as a value of the item “task request ID” of the corresponding data record of task-request task-requesting-person data 15a, whereby the two data records are associated together.

A value of the item “point setting ID” is an identifier to identify a point setting. A value of the item “point setting ID” is set for each pattern of setting of the number of points, such as “P01”, “P02”, “P03”, etc.

A value of the item “number of providing points” is the number of providing points. The number of points determined by a task requesting person 2 is set at the item “number of providing points”.

In a process of providing points, when a data record of task-request point setting data 18 has been set, that is, when a data record having the same value of the task request ID as the task request ID with respect to the task in process exists, the reward providing unit 14 obtains the value of the item “number of providing points” of the data record and determines the obtained value as the number of points to be provided to the task executing person.

When, in a process of providing points, a corresponding data record of task-request point setting data 18 has not been set, that is, when there is no data record having the same value of the task request ID as the task request ID with respect to the task in process, the reward providing unit 14 obtains the value of the item “number of providing points” of the point setting data 17 in the same way as the above-described way described with reference to the first embodiment and determines the obtained value as the number of points to be provided to the task executing person.

According to the task request system 1 of the present embodiment, a task requesting person sets the number of points to be provided to a task executing person. Therefore, it is possible to determine the number of providing points depending on, for example, the degree of difficulty of a task, the degree of importance of a task, or the like. Thus, high flexibility can be provided.

Any ones of the embodiments described above can be suitably combined together. For example, the second embodiment and the third embodiment may be combined, to set the number of points, to be provided at a time when acceptance information is registered, at a time when task request information is input by a task requesting person.

Deletion of data in each of the above-described embodiments may be not only physical deletion of physically deleting a data record, but also logical deletion by flagging that indicates deletion, for example.

Points in the above described embodiments are an example of a reward. Alternatively, a reward provided to a task executing person may be a virtual currency, an electronic money, a bond, a deposit at a financial institution, or the like. In addition, points provided to a task executing person as a reward can be used for a variety of purposes. For example, points provided to a task executing person as a reward may be interchanged with a virtual currency, points, etc. within a particular enterprise.

Points may be provided at a time other than a time of providing points described above with reference to the embodiments. For example, the reward providing unit 14 of the information processing apparatus 10 may transmit a point providing request signal to the score managing apparatus 20 at a time when a task executing person clicks or taps a link included in a task request notifying e-mail.

A task request system 1 according to any one of the above-described embodiments may be used in a variety of ways. For example, a task request system 1 may be used for, in an enterprise, a manager to request a plurality of employees simplified tasks such as taking e-learning courses or inputting of attendance, and collect the task results. A task request system 1 can also be used as a system for requesting a sole proprietor or freelance contractor to execute a task.

A task request system 1 may be used in a system that uses both free points provided free of charge and paid points to be purchased. In that case, paid points may be used as points in any of the above-described embodiments as free points provided by a task requesting person to a task executing person as a gratuity.

Points with respect to any one of the above-described embodiments may be paid points. In this case, the information processing apparatus 10 subtracts the number of points of a task requesting person and adds the same number of points as the number of points, thus subtracted, to a task executing person.

Such paid points may be managed separately from free points, and, purposes for which paid points can be used may be different from purposes for which free points can be used. Also, free points may be convertible with paid points.

Apparatuses described with respect to the embodiments described above are merely indicative of one of a plurality of computing environments for carrying out the embodiments disclosed herein.

In an embodiment, the information processing apparatus 10 includes a plurality of computing devices (or apparatuses) such as a server cluster. The plurality of computing devices are configured to communicate with each other via any type of communication link, such as a network, a shared memory, or the like, and perform processes disclosed herein. Similarly, the score managing apparatus 20 may include a plurality of computing devices (or apparatuses) configured to communicate with each other.

Further, the information processing apparatus 10 and the score managing apparatus 20 can be configured to share disclosed processing steps, for example, a task request process depicted in FIG. 8, in any one of various combinations. For example, a score data update process may be performed by also the information processing apparatus 10. The elements of the information processing apparatus 10 and the score managing apparatus 20 may be grouped into a single server apparatus, or the elements of either one of the information processing apparatus 10 and the score managing apparatus 20 may be included in a plurality of separate apparatuses.

The score managing apparatus 20 according to any one of the above-described embodiments may receive a score data update request from an apparatus other than the information processing apparatus 10. By separating the roles of the information processing apparatus 10 and the roles of the score managing apparatus 20, the versatility of the score managing apparatus 20 is highly maintained.

Thus, the score managing apparatus 20 may receive a score data update request from an apparatus unrelated to the information processing apparatus 10, for example, an information processing apparatus for performing a process of recruiting persons who can execute a task, or the like.

Further, the roles are separated between an application executed by the above-described information processing apparatus 10, that is, an application which performs operations together with providing points, using points, and so forth, and an application executed by the above-described score managing apparatus 20, that is, an application which manages points (a score) for each user and performs addition and subtraction of points. In the above-described example, these applications are implemented in the separate apparatuses, but may be implemented in the same apparatus.

As a result, a task request system 1 has a highly scalable system. For example, without changing the application that manages points (or score) for each user and performs point addition, subtraction, etc., it is possible to add any one of various applications, such as an application that recruits persons who can execute a task and works together with processes of providing points, using points, and so forth.

The information processing apparatus 10 or the score managing apparatus 20 according to each of the embodiments described above may be, for example, an output apparatus such as a projector (PJ) or a digital signage, a head up display (HUD) apparatus, an industrial machine, a medical apparatus, a network home appliance, an automobile (a connected car), a personal computer (PC), a cellular phone, a tablet terminal, a game machine, a personal digital assistant (PDA), a digital camera, a wearable PC, or a desktop PC.

The functions of each of the embodiments described above may be implemented by one or more processing circuits. As used herein, a “processing circuit” may be a processor programmed to perform each function by software, such as a processor implemented in an electronic circuit, or a device such as an application specific integrated circuit (ASIC), a digital signal processor (DSP), a field programmable gate array (FPGA), or a conventional circuit module, designed to perform each function described above.

Although the task request systems, information processing apparatuses, task request methods, and non-transitory recording mediums have been described with reference to the embodiments, the present invention is not limited to the embodiments and various variations and modifications can be made within the scope of the present invention.

What is claimed is:

1. A task request system comprising
circuitry configured to
receive, from a task requesting person, task request information indicating a request for a task including an indication of a completion time limit,
receive, from a task executing person, task completion information indicating a completion of the task,
in response to receiving time limit delay information indicating a delay of the completion time limit that is included in the task request information, provide a first reward that is previously set to the task executing person, and
in response to receiving the task completion information, provide a second reward that is previously set to the task executing person.

2. The task request system according to claim 1, further comprising a score managing database configured to manage a score of each user,
wherein
the circuitry is further configured to increase the score, as the first reward or the second reward to a user who is the task executing person.

3. The task request system according to claim 1, wherein
the circuitry is further configured to
use a value of a total of the first reward and the second reward that is provided in response to receiving the task completion information by a delayed completion time limit,
the value being the same as a value of the second reward provided in response to receiving the task completion information by the completion time limit included in the task request information without receiving the time limit delay information.

4. The task request system according to claim 1, wherein
the circuitry is further configured to
display a screen page on a terminal used by the task executing person or the task requesting person.

5. The task request system according to claim 4, wherein
the circuitry is further configured to
cause the terminal used by the task requesting person to display a task-requesting-person task list of tasks that the task requesting person requests, and
cause the terminal used by the task executing person to display a task-executing-person task list of tasks that the task executing person is requested to execute.

6. The task request system according to claim 5, wherein
the task-requesting-person task list includes a ratio of the number of task executing persons each of whom has completed a requested task with respect to the number of task executing persons whom the task requesting person has requested to execute tasks.

7. The task request system according to claim 1, wherein
the circuitry is further configured to
send a notifying e-mail to an e-mail address of the task executing person in response to receiving the task request information.

8. The task request system according to claim 1, wherein
the circuitry is further configured to
send a notifying e-mail to an e-mail address of the task requesting person in response to receiving the task completion information.

9. The task request system according to claim 1, wherein
the circuitry is further configured to
in response to receiving the task completion information, provide the second reward to the task executing person after receiving acceptance information from the task requesting person.

10. The task request system according to claim 1, wherein
the circuitry is further configured to
receive from the task requesting person, together with the task request information, information to set the first reward and the second reward with respect to the task, and
provide the first reward or the second reward to the task executing person, on the basis of the information to set the first reward and the second reward with respect to the task.

11. An information processing apparatus, comprising
circuitry configured to
receive, from a task requesting person, task request information indicating a request for a task including an indication of a completion time limit,
receive, from a task executing person, task completion information indicating a completion of the task,
in response to receiving time limit delay information indicating a delay of the completion time limit that is included in the task request information, request an apparatus, managing a reward, to provide a first reward that is previously set to the task executing person, and
in response to receiving the task completion information, request the apparatus, managing a reward, to provide a second reward that is previously set to the task executing person.

12. A task request method comprising:
receiving, from a task requesting person, task request information indicating a request for a task including an indication of a completion time limit,
receiving, from a task executing person, task completion information indicating a completion of the task,
in response to receiving time limit delay information indicating a delay of the completion time limit that is included in the task request information, providing a first reward that is previously set to the task executing person, and
in response to receiving the task completion information, providing a second reward that is previously set to the task executing person.

13. A non-transitory recording medium storing a program, which, when being executed by a computer, causes the computer to perform the task request method according to claim 12.
